(19) United States
(12) Patent Application Publication
(10) Pub. No.: US 2025/0144540 A1
(43) Pub. Date: May 8, 2025

(54) FUSIBLE TOY BEAD AND METHOD FOR PRODUCING FUSIBLE TOY BEAD

(71) Applicant: EPOCH COMPANY, LTD., Tokyo (JP)

(72) Inventor: Ryo SAKAI, Tokyo (JP)

(73) Assignee: EPOCH COMPANY, LTD., Tokyo (JP)

(21) Appl. No.: 18/937,406

(22) Filed: Nov. 5, 2024

(30) Foreign Application Priority Data
Nov. 6, 2023 (JP) 2023-189355

(51) Int. Cl. A63H 33/14; B29C 45/16; B29K 29/00; B29K 105/00; B29L 31/00

(52) U.S. Cl. CPC A63H 33/14; B29C 45/1634; B29K 2029/04; B29K 2105/0032; B29K 2995/0021; B29L 2031/772

(57) ABSTRACT

A fusible toy bead includes a water-soluble resin and two or more pigments as coloring agents, the water-soluble resin includes polyvinyl alcohol as a main component, and includes 3% by weight of polypropylene, and two or more colors appear on a surface in a mixed manner without intermixing with each other.

### CROSS-REFERENCE TO RELATED APPLICATIONS

This application claims priority from Japanese Patent Application No. 2023-189355 filed on Nov. 6, 2023. The entire content of the priority application is incorporated herein by reference.

### TECHNICAL FIELD

The present disclosure relates to a fusible toy bead and a method for producing a fusible toy bead.

### BACKGROUND ART

Recently, there are toys called toy beads for playing such that beads such as small resin spheres or tubular resin bodies are fused together to create various decorative bodies and the like. For example, Patent Literature 1 discloses a fusible toy bead in which beads can be fused together simply by spraying a liquid such as water to create bead combinations of various shapes.

### CITATION LIST

### Patent Literature

Patent Literature 1: JP2013-143986A

### SUMMARY OF INVENTION

In the toy bead as disclosed in Patent Literature 1 described above, beads of various colors are provided, and this allows for producing a decorative item having a pattern rich in color. In order to further improve the playfulness of this type of toy bead, there is a demand for a bead having a marble pattern color in which two or more colors appear in a mixed manner without intermixing with each other.

An object of the present disclosure is to provide a fusible toy bead having a marble pattern color and having excellent appearance, and a method for producing such a fusible toy bead.

A fusible toy bead according to an embodiment of the present disclosure includes a water-soluble resin and two or more pigments as coloring agents, in which the water-soluble resin comprises polyvinyl alcohol as a main component and comprises 3% by weight of polypropylene, and two or more colors appear on a surface in a mixed manner without intermixing with each other.

A method for producing a fusible toy bead according to an embodiment of the present disclosure, includes preparing a water-soluble resin comprising polyvinyl alcohol as a main component and 3% by weight of polypropylene, dividing the water-soluble resin into two or more parts and mixing each of two or more pigments of different colors into each of the parts of the resin to form two or more types of colored pellets having different colors, and injection molding the two or more types of colored pellets with a mold, while mixing the two or more types of colored pellets.

The present disclosure allows for providing a fusible toy bead having a marble pattern color and having excellent appearance, and a method for producing such a fusible toy bead.

### BRIEF DESCRIPTION OF DRAWINGS

FIG. 1A is a front view illustrating the appearance of a fusible toy bead in a first aspect according to an embodiment of the present disclosure, and FIG. 1B is a front view illustrating the appearance of a fusible toy bead in a second aspect according to the embodiment of the present disclosure.

FIG. 2 is a photograph showing the appearance of a fusible toy bead in a third aspect according to the embodiment of the present disclosure.

FIGS. 3A and 3B are schematic views showing a method for producing the fusible toy bead in the second aspect according to the embodiment of the present disclosure. FIG. 3A is a plan view of a molded product that is provided with fusible toy beads, and FIG. 3B is a side view of the molded product that is provided with fusible toy beads.

FIG. 4 is a schematic view illustrating the appearance of a sample used for a strength test of a fusible toy bead in an example.

FIG. 5 is a schematic view of a test device used for the strength test of the fusible toy bead in the example.

### DESCRIPTION OF EMBODIMENTS

As used herein, the words “a” and “an” and the like carry the meaning of “one or more.” The phrase “two or more colors appear on a surface in a mixed manner without intermixing with each other”, “appear in a mixed manner” and the like mean not that two or more colors mix together to make a different color but that two or more colors make some patterns such as waves, spots, stripes and cracks on the surface randomly.

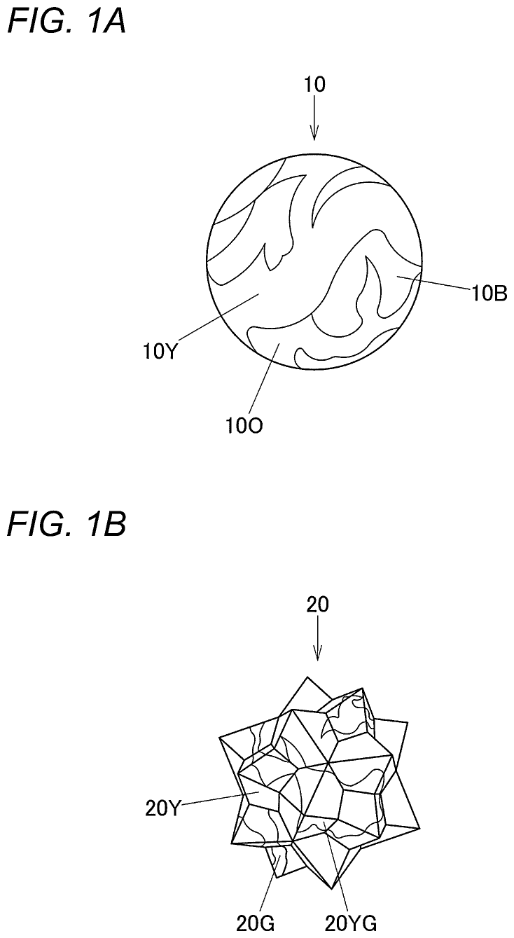

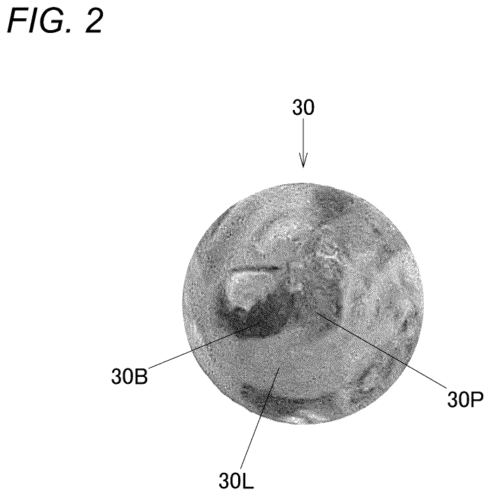

An embodiment will be described with reference to the drawings. As shown in FIG. 1A, a fusible toy bead (hereinafter referred to as a “first bead 10”) in a first aspect according to the embodiment of the present disclosure is a spherical bead having a particle diameter of approximately 5 mm. As shown in FIG. 1B, a fusible toy bead (hereinafter, referred to as a “second bead 20”) in a second aspect according to the embodiment of the present disclosure is a substantially star-shaped bead having a size of approximately 5 mm. As shown in a photograph in FIG. 2, a fusible toy bead (hereinafter referred to as a “third bead 30”) in a third aspect according to the embodiment of the present disclosure is a spherical bead having a particle diameter of approximately 5 mm.

The surfaces of the beads 10, 20, and 30 have two or more colors that appear on the surface in a mixed manner without intermixing with each other. As shown in FIG. 1A, on the surface of the first bead 10, for example, a yellow portion 10Y made of yellow, an orange portion 100 made of orange, and a brown portion 10B made of brown appear in a mixed manner. As shown in FIG. 1B, on the surface of the second bead 20, for example, a yellow portion 20Y made of yellow, a yellow-green portion 20YG made of yellow-green, and a green portion 20G made of green appear in a mixed manner.

As shown in the photograph in FIG. 2, on the surface of the third bead 30, a light blue portion 30L made of light blue, a purple portion 30P made of purple, and a blue portion 30B made of blue appear in a mixed manner. In this way, on the surfaces of the beads 10, 20, and 30, three different colors of the similar color appear in a mixed manner without intermixing with each other to achieve a so-called marble pattern color. Therefore, a fusible toy bead having excellent appearance can be provided.

The beads 10, 20, and 30 are made of synthetic resin that is colored by blending a water-soluble resin with two or more pigments as coloring agents, and is formed by injection molding using a mold. The water-soluble resin contains polyvinyl alcohol (PVA) as a main component and contains 3% by weight of polypropylene (PP). This allows for achieving sufficient welding strength for each of the beads 10, 20, and 30. In this specification, the phrase “containing as a main component” refers to containing 50% by weight or more of the component with respect to the total amount. That is, each of the beads 10, 20, and 30 according to the present embodiment is made of a water-soluble resin containing at least 50% by weight or more of polyvinyl alcohol with respect to the total amount. Examples of the pigments include Food Red No. 3 (Erythrosine) and its Aluminum Lake, Food Blue No. 1 (Brilliant Bule FCF) and its Aluminum Lake, Food Bule No. 2 (Indigo Carmine) and its Aluminum Lake, Food Yellow No. 4 (Tartrazine) and its Aluminum Lake, Food Yellow No. 5 (Sunset Yellow FCF) and its Aluminum Lake, Titanium Dioxide, Vegetable carbon, Gold sheen #120608, Silver Lustre #120602, Silver Sheen #120601, and the like.

Next, a method for producing the beads 10, 20, and 30 will be described. First, a water-soluble resin containing polyvinyl alcohol as a main component and containing 3% by weight of polypropylene with respect to the total weight is prepared (a resin forming process). The water-soluble resin containing polypropylene has a lower fluidity, and this allows for suppressing intermixing of three types of colored pellets to be described later, with each other. Further, the small content of polypropylene achieves suppressing an excessive decrease in the welding strength, and this allows sufficient welding strength to be maintained. Next, the prepared water-soluble resin is divided into three portions, and three different colored (for example, when the first beads 10 is to be produced, the three colors are yellow, orange, and brown) pigments are mixed into each portion to form three types of different colored pellets (a mixing process).

Next, the three types of colored pellets are injection molded while being mixed using a dedicated mold (a molding process). This injection molding is performed in a temperature range of 145° C. to 165° C. Specifically, a cooler for the molding machine is used for maintaining the temperature in the molding machine within this temperature range. Performing injection molding in such a temperature range causes polyvinyl alcohol, which is highly hydrophilic and soluble in warm water, to easily melt, and causes polypropylene to melt hardly and to keep its hardness. Thus, polyvinyl alcohol and polypropylene are suppressed to be intermixed with each other. When the injection molding described above is performed, changing the mixing ratio of the three types of colored pellets allows for changing the intensity of each color in the produced bead.

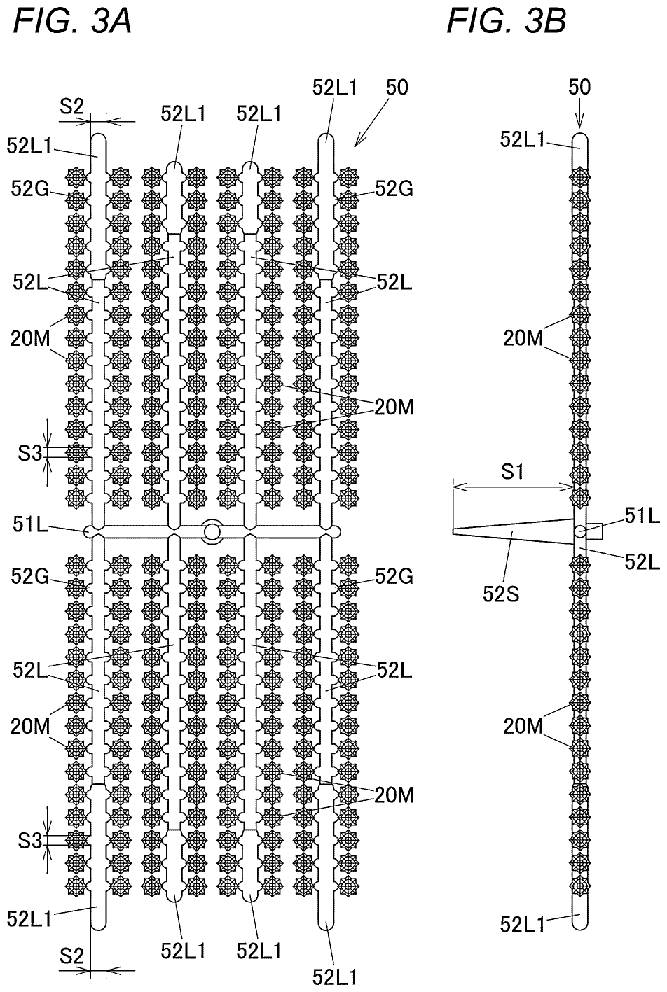

Here, FIGS. 3A and 3B show schematic views of a molded product 50 that is taken out from the mold after performing the injection molding described above using a dedicated mold in the process for producing the second bead 20. Hereinafter, of the molded product 50, a portion corresponding to the spool of the mold is referred to as a spool portion 52S, a portion corresponding to the runner of the mold is referred to as a first runner portion 51L, a second runner portion 52L (a side close to the spool portion 52S is referred to as the first runner portion 51L), a portion corresponding to the gate of the mold is referred to as a gate portion 52G, and a portion corresponding to each molded second bead 20 is referred to as a second bead portion 20M. A portion of the second runner portion 52L on the distal end side (the side far from the first runner portion 51L) is referred to as a second runner distal end portion 52L1.

The molded product 50 shown in FIGS. 3A and 3B is an example, and as shown in the drawing, a large number of second bead portions 20M are molded by one time of injection molding. In the example shown in FIG. 3A, 240 second bead portions 20M are molded by one time of injection molding.

As shown in FIG. 3B, in the molded product 50, a length S1 of the spool portion 52S is, for example, 40 mm, which is shorter than the length (for example, 50 mm) of the spool portion of the molded product molded during the process for producing a fusible toy bead having no marble pattern color in the related art. Using the mold in which the length S1 of the spool portion 52S is shorter than that in the producing method in the related art achieves shortening the residence time of the three types of colored pellets in the mold compared with that in the producing method in the related art. Accordingly, the colored pellets are suppressed to be mixed with each other. In other words, the colored pellets are suppressed to be integrated and uniformly intermixed with each other.

As shown in FIG. 3A, in the molded product 50, a diameter S2 of the second runner distal end portion 52L1 is larger than the diameter of the other portion of the second runner portion 52L and the diameter of the first runner portion 51L. Using a mold in which the diameter S2 of the second runner distal end portion 52L1 is larger than the diameter of the other portion of the second runner portion 52L and the diameter of the first runner portion 51L compensates for the lack of fluidity of the water-soluble resin that constitutes each colored pellet at the distal end portion of the runner of the mold, and this allows for preventing the occurrence of partial underfill (so-called short shot) in the second bead portion 20M.

As shown in FIG. 3A, in the molded product 50, a diameter S3 of the gate portion 52G is, for example, 1 mm, which is 20% or more of the diameter (approximately 5 mm in the present embodiment) of the second bead 20 to be produced. Using a mold in which the diameter S3 of the gate portion 52G is 20% or more of the diameter of the second bead 20 to be manufactured compensate for the lack of fluidity of the water-soluble resin that constitutes each colored pellet at the entrance of the gate in the mold, and this allows for reducing the crossing of the colored pellets.

After injection molding is performed using the dedicated mold as described above, the second bead portions 20M are cut out from the taken-out molded product 50, and the second beads 20 are produced. In the second beads 20 produced in this manner, each colored pellet is suppressed to be intermixed with each other during injection molding, and this achieves a marble pattern color in which the three colors appear in a mixed manner without intermixing with each other. Thus, the present embodiment allows for providing a method for producing a fusible toy bead having a marble pattern color and having excellent appearance.

The embodiment of the present disclosure described above, allows for providing a fusible toy bead according to the following aspects.

A fusible toy bead according to the first aspect is a fusible toy bead that is formed by blending a water-soluble resin with a pigment, which is a coloring agent, in which the water-soluble resin contains polyvinyl alcohol as a main component, and contains 3% by weight of polypropylene, and in which two or more colors appear on a surface in a mixed manner without intermixing with each other.

In this configuration, polypropylene is contained in the water-soluble resin, so that the fluidity of the water-soluble resin is reduced, and the colors that appear on the surface of the fusible toy bead are suppressed to be intermixed with each other in the process for producing the fusible toy bead. Further, the small content of polypropylene in the water-soluble resin suppresses an excessive decrease in the welding strength, and sufficient welding strength is maintained. Accordingly, a fusible toy bead having a marble pattern color and having excellent appearance is provided.

The embodiment of the present disclosure described above allows for providing a method for producing a fusible toy bead according to the following aspects.

A method for producing a fusible toy bead according to a first aspect is a method for producing a fusible toy bead that is formed by blending a water-soluble resin with a pigment, which is a coloring agent, the method including: a resin forming process of preparing the water-soluble resin that contains polyvinyl alcohol as a main component, and that contains 3% by weight of polypropylene; a mixing process of dividing the water-soluble resin into two or more parts and mixing the pigments of different colors into each of the parts to form two or more types of colored pellets of different colors; and a molding process of injection molding the two or more types of colored pellets while mixing the two or more types of colored pellets using a mold.

According to this producing method, a small amount of polypropylene contained in the water-soluble resin reduces the fluidity of the water-soluble resin, and this suppresses the two or more types of colored pellets in the molding process to be intermixed with each other. Therefore, it is possible to produce a fusible toy bead having a marble color and having excellent appearance.

In the method for producing a fusible toy bead according to a second aspect, in the molding process, the mold is used in which a length of a spool portion is 30 mm or more and 40 mm or less.

In this producing method, the mold is used in which the length of the portion corresponding to the spool of the molded product is smaller than the length (for example, 50 mm) of the portion corresponding to the spool of the molded product molded in the process for producing the fusible toy bead having no marble pattern color in the related art, and this allows the residence time of the two or more types of colored pellets in the mold to be shorter than that in the producing method in the related art. Thus, the two or more types of colored pellets are further suppressed to be intermixed with each other in the molding process, and this allows for effectively producing a fusible toy bead having a marble pattern color and having excellent appearance.

In the method for producing a fusible toy bead according to a third aspect, in the molding process, the mold is used in which a diameter of a distal end portion of a runner portion is larger than a diameter of the other portion of the runner portion.

In this producing method, in the molding process, the lack of fluidity of the water-soluble resin of the two or more types of colored pellets is compensated for at the distal end portion of the runner of the mold, and thus, this suppresses the occurrence of partial underfill in the fusible toy bead of the molded product, to effectively producing a fusible toy bead having excellent appearance.

In the method for producing a fusible toy bead according to a fourth aspect, in the molding process, the mold is used in which a diameter of a gate portion is 20% or more and 30% or less of a diameter of the fusible toy bead to be produced.

In this producing method, in the molding process, the lack of fluidity of the water-soluble resin of the two or more types of colored pellets is compensated for at the entrance of the gate in the mold, and this reduces the crossing of the two or more types of colored pellets. Thus, a fusible toy bead having excellent appearance can be effectively produced.

In the method for producing a fusible toy bead according to a fifth aspect, in the molding process, injection molding is performed in a temperature range of 145° C. to 165° C.

In this producing method, in the molding process, polyvinyl alcohol easily melts, while polypropylene melts hardly and remains hard. Therefore, polyvinyl alcohol and polypropylene are suppressed to be intermixed with each other, and a fusible toy bead having a marble pattern color and having excellent appearance can be effectively produced.

Although the embodiment of the present disclosure has been described above, the present disclosure is not limited to the embodiment described above, and various modifications can be made without departing from the gist thereof. For example, in the embodiment described above, a fusible toy bead in which three different colors of the similar color appear in a mixed manner without intermixing with each other and a method for producing the fusible toy bead are exemplified. However, the number of colors that appear on the surface of the fusible toy bead is not limited to three, and the color combinations are not limited to colors of the similar color. A fusible toy bead may be produced in which two or four or more colors appear on the surface. In this case, in the mixing process, colored pellets are formed in a number corresponding to the number of colors that are to appear on the surface of the fusible toy bead to be produced.

### EXAMPLES

In the examples, samples were prepared in which 15 second beads 20 of three types each having a different content of polypropylene in the water-soluble resin were welded and a tensile test was performed on each sample using a measuring instrument to measure the tensile strength at the time of breakage, and the difference in the weld strength due to the difference in the content of polypropylene was verified.

In a first sample (hereinafter, referred to as “Example 1”), the content of polypropylene was set to 3% by weight with respect to the total amount of the water-soluble resin as in the embodiment described above. In a second sample (hereinafter, referred to as “Comparative Example 1”), the content of polypropylene was set to 4% by weight with respect to the total amount of the water-soluble resin. In a third sample (hereinafter referred to as “Comparative Example 2”), the content of polypropylene was set to 6% by weight with respect to the total amount of the water-soluble resin. The samples each contain polyvinyl alcohol as a main component in the water-soluble resin, and the contents thereof are the same.

A water-soluble resin having a content of polypropylene of less than 3% by weight with respect to the total amount of the water-soluble resin was not included in the samples according to the present example because it was anticipated that the fluidity of the water-soluble resin cannot be sufficiently reduced.

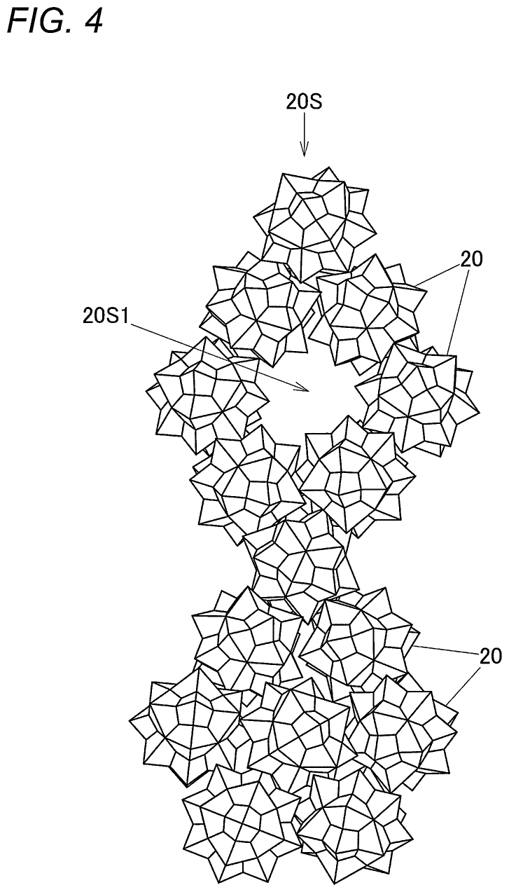

Samples 20S that are prepared as Example 1, Comparative Example 1, and Comparative Example 2 are shown in FIG. 4. The sample 20S was prepared by pouring water on the 15 second beads 20 to weld the 15 second beads 20 into the shape shown in FIG. 4, and then completely drying the 15 second beads 20 for 48 hours. In this sample 20S, an annular portion 20S1 was provided in a part of the sample 20S to facilitate the tensile test.

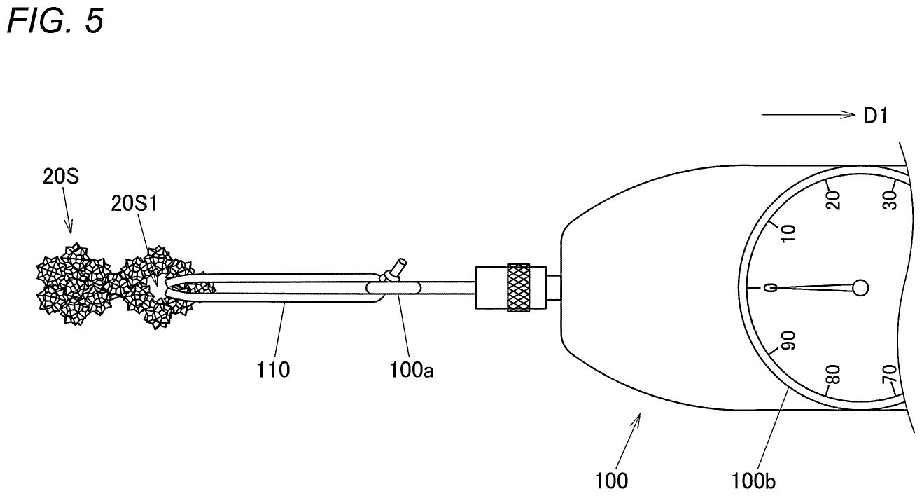

The tensile test was performed using a measuring instrument 100, model number AWF-100, manufactured by Aiko Engineering Co., Ltd. As shown in FIG. 5, in the tensile test, for the samples 20S according to Example 1, Comparative Example 1, and Comparative Example 2, one end portion of a string 110 was allowed to pass through the annular portion 20S1 and the other end portion of the string 110 was hooked onto a hook portion 100a of the measuring instrument 100. Then, the measuring instrument 100 was pulled in a direction D1 away from the samples 20S with the positions of the samples 20S fixed, and the tensile strength of the samples 20S was measured by reading a scale 100b of the measuring instrument 100 when the samples 20S broke.

As a result of performing the tensile test on the samples 20S as described above, in Example 1, the value of the scale 100b of the measuring instrument 100 when the samples 20S broke was 500 g. In Comparative Example 1, the value of the scale 100b of the measuring instrument 100 when the samples 20S broke was 90 g. In Comparative Example 2, the value of the scale 100b of the measuring instrument 100 when the samples 20S broke was 40 g.

From the above test results, it was found that the second beads 20 used in Example 1 had welding strength of five times or more as compared with the second beads 20 used in Comparative Example 1, and had welding strength of 12 times or more as compared with the second beads 20 used in Comparative Example 2. From this, it has been confirmed that for the fusible toy bead, sufficient weld strength can be ensured by setting the content of polypropylene in the water-soluble resin of the fusible toy bead to 3% by weight with respect to the total amount of the water-soluble resin. It has also been confirmed that setting the content of polypropylene in the water-soluble resin greater than 3% by weight resulted in the rapidly decrease in the welding strength of the fusible toy bead.

What is claimed is:

1. A fusible toy bead comprising:
a water-soluble resin; and
two or more pigments as coloring agents,
wherein the water-soluble resin comprises polyvinyl alcohol as a main component, and comprises 3% by weight of polypropylene, and
wherein two or more colors appear on a surface in a mixed manner without intermixing with each other.

2. A method for producing a fusible toy bead comprising:
preparing a water-soluble resin comprising polyvinyl alcohol as a main component and 3% by weight of polypropylene;
dividing the water-soluble resin into two or more parts and mixing each of two or more pigments of different colors into each of the parts of the resin to form two or more types of colored pellets having different colors; and
injection molding the two or more types of colored pellets with a mold, while mixing the two or more types of colored pellets.

3. The method for producing a fusible toy bead according to claim 2,
wherein in the injection molding, the mold has a length of a spool portion of 30 mm or more and 40 mm or less.

4. The method for producing a fusible toy bead according to claim 2,
wherein in the injection molding, the mold has a larger diameter of a distal end portion at a runner portion than a diameter of the other portion at the runner portion.

5. The method for producing a fusible toy bead according to claim 2,
wherein in the injection molding, the mold has a diameter of a gate portion of 20% or more and 30% or less with respect to a diameter of the fusible toy bead.

6. The method for producing a fusible toy bead according to claim 2,
wherein the injection molding is performed at a temperature of 145° C. to 165° C.
